(19) United States
(12) Patent Application Publication
(10) Pub. No.: US 2006/0118489 A1
(43) Pub. Date: Jun. 8, 2006

(54) System and method for processing identified metabolites

(75) Inventors: Jose Castro-Perez, Manchester (GB); Robert Plumb, Milford, MA (US); Jane Kirby, Great Warford (GB)

Correspondence Address: WATERS INVESTMENTS LIMITED;C/O WATERS CORPORATION, 34 MAPLE STREET - LG, MILFORD, MA, 01757, US

(73) Assignee: WATERS INVESTMENTS LIMITED, New Castle, DE (US)

(21) Appl. No.: 11/210,977

(22) Filed: Aug. 24, 2005

Related U.S. Application Data
(63) Continuation of application No. PCT/US04/05652, filed on Feb. 24, 2004.
(60) Provisional application No. 60/449,534, filed on Feb. 24, 2003.
(60) Provisional application No. 60/531,044, filed on Dec. 19, 2003.

(51) Int. Cl. B01D 15/08

(52) U.S. Cl. 210/656; 250/281; 356/300; 356/326

(57) ABSTRACT

A method of rapidly analyzing unexpected metabolites in a metabolite analyzing system is disclosed. A control sample is run and analyzed to generate an exclusion list of unwanted sample components. A single analyte sample is then run and programmatically uses the exclusion list containing the unwanted metabolites to dynamically filter out data regarding components present in both the control sample and the analyte sample. The remaining components in the analyte sample are analyzed for unexpected metabolites of interest. The present invention allows for the analysis to be automated and eliminates the need for a second analyte sample run for the purpose of eliminating common components in the samples.

### CROSS REFERENCE TO RELATED APPLICATIONS

This application claims benefit of and is a continuation of International Application No. PCT/US2004/005652, filed Feb. 24, 2004 and designating the United States, which claims benefit of and priority to U.S. Provisional Application Nos. 60/449,534, filed Feb. 24, 2003, and 60/531,044, filed Dec. 19, 2003. The contents of these applications are incorporated herein by reference in their entirety.

### FIELD OF THE INVENTION

The illustrative embodiment of the present invention relates generally to metabolic analysis and more particularly to the identification and analysis of unexpected metabolites using an exclusion list of unwanted metabolites programmatically generated from a control sample.

### BACKGROUND

Metabolism may be defined as the chemical changes that take place in a cell or an organism that are used to produce energy and the basic materials which are needed for important life processes such as mitosis. The byproducts of the chemical reaction may be referred to as metabolites. By analyzing and identifying the metabolites that are present in a sample, it is possible to determine the route of metabolism. For example, an analysis of metabolites in urine may be used to determine what substances were ingested by the individual that produced the urine. The identification and analysis of the metabolites is often performed using liquid chromatography in combination with mass spectrometry.

Liquid chromatography separates the individual components contained within a sample so that they may be identified. In liquid chromatography two phases are involved, a mobile phase and a stationary phase. A liquid sample mixture (the “mobile phase”) is passed through a column packed with particles (the “solid phase”) in order to effect a separation of the constituent components. The particles in the column may or may not be coated with a liquid designed to react with the mobile phase. The constituent components in the mobile phase (i.e.: in the sample) pass through the packed column at different rates based upon a number of factors. The separation of the sample into its constituent components is then analyzed by observing the sample as it exits the far end of the column.

The speed with which the different constituent components pass through the column depends on the interaction of the mobile phase with the solid phase. The components in the sample may physically interact with the particles or a substance coating the particles such that their movement through the column is retarded. Different components in the sample being analyzed will react differently to the particular particle and/or coating by interacting with the particular particles and/or coating with differing degrees of strength depending upon the chemical makeup of the component. Those components which tend to bond more strongly to the particles and/or coating will pass through the column more slowly than those components which bond weakly or not at all with the particle/coating. In addition to chemical reactions, the size of the components in the sample may dictate the speed with which they pass through the column. For example, in gel-permeation chromatography, different molecules in the solution being analyzed pass through a matrix containing pores at different speeds thereby effecting a separation of the different molecules in the sample. In size exclusion chromatography the size of the particles and their packing method in the column combine with the size of the components in the sample to determine the rate at which a sample passes through the column(as only certain size components may easily traverse the gaps/interstitial spaces between particles).

The separated sample travels into a detector at the far end of the column where the retention time is calculated for the various components in the sample. The retention time is the time required for the sample to travel from the injection port (where the sample is introduced into the column) through the column and to the detector. The amount of the component exiting the solid phase may be graphed against the retention time to form a chart with peaks which are known as chromatographic peaks. The peaks identify the different components.

The separated components may be fed into a mass spectrometer for further analysis in order to determine their chemical make-up. Systems that have one mass spectrometer stage combined with a liquid chromatography stage are referred to as LC-MS systems. Systems with two mass spectrometer stages are referred to as LC-MS-MS systems. A mass spectrometer takes a sample as input and ionizes the sample to create positive ions. A number of different ionization methods may be used including the use of an electronic beam. The positive ions are then separated by mass in a first stage separation commonly referred to as MS1. The mass separation may be accomplished by a number of means including the use of magnets which divert the positive ions to differing degrees based upon the weight of the ions. The separated ions then travel into a collision cell where they come in contact with a collision gas or other substance which interacts with the ions. The reacted ions then undergo a second stage of mass separation commonly referred to as MS2.

The separated ions are analyzed at the end of the mass spectrometry stage(or stages). The analysis graphs the intensity of the signal of the ions versus the mass of the ion in a graph referred to as a mass spectrum. The analysis of the mass spectrum gives both the masses of the ions reaching the detector and the relative abundances. The abundances are obtained from the intensity of the signal. The combination of liquid chromatography with mass spectrometry may be used to identify chemical substances such as metabolites. When a molecule loses electrons covalent bonds often break, resulting in an array of positively charged fragments. The mass spectrometer measures the masses of the fragments which may then be analyzed to determine the structure and/or composition of the original molecule. The information may be used to isolate a particular substance in a sample.

Conventionally, the analysis of metabolites involves three separate sample runs. The first sample run is a control. Following the control sample run a first analyte sample run is conducted. The chromatographic peaks from the analyte sample results are compared to the chromatographic peaks of the control and the results of the comparison are used to eliminate the components that appear in both samples. A second analyte sample run is then conducted that focuses on the components unique to the analyte sample in order to identify unexpected metabolites that appear in the analyte sample but not in the control sample. Unfortunately, the comparison of the control sample to the first analyte sample is a time intensive procedure requiring in most cases direct human participation. A less popular alternative uses a generic list of unwanted components, but the list is usually not specifically tailored to the sample runs being conducted unless combined with the comparison method. Additionally the generic list tends to be larger than a list generated by comparison between an analyte sample and a control sample and therefore takes longer to process.

### SUMMARY OF THE INVENTION

The illustrative embodiment of the present invention provides an automated mechanism for rapidly analyzing unexpected metabolites in a metabolite analyzing system. A control sample is run and analyzed to generate an exclusion list of unwanted sample components. A single analyte sample is then run and programmatically uses the exclusion list containing the unwanted metabolites to dynamically filter out data regarding components present in both the control sample and the analyte sample. The remaining components in the analyte sample are analyzed for unexpected metabolites of interest. The present invention allows for the analysis to be automated and eliminates the need for a second analyte sample run for the purpose of eliminating common components in the samples.

In one embodiment, a method for analyzing metabolites includes the step of programmatically analyzing a single control sample to determine unwanted metabolites. Following the determination of the unwanted metabolites, the metabolite analysis system adds the unwanted metabolites to a saved exclusion list. An analyte sample is then programmatically evaluated for unexpected metabolites by the metabolite analysis system using the exclusion list.

In another embodiment, a metabolite analysis apparatus includes a chromatography module. The apparatus also includes at least one mass spectrometry module. The apparatus further includes an electronic device holding a storage location. The storage location holds chromatographic data generated by the chromatography module for a single control sample. An exclusion list of identified metabolites is also part of the metabolite analysis apparatus. The exclusion list is programmatically applied to an analyte sample to help identify unexpected metabolites.

### BRIEF DESCRIPTION OF THE DRAWINGS

FIG. 1 depicts an environment suitable for practicing the illustrative embodiment of the present invention;

FIG. 2 is a flow chart of the sequence of steps used to perform liquid chromatography and mass spectrometry;

FIG. 3 is a flow chart of the prior art sequence of steps used to exclude unwanted metabolites from an analyte sample analysis;

FIG. 4 is a flow chart of the sequence of steps followed by the illustrative embodiment of the present invention to dynamically filter data in an analyte sample; and

FIG. 5 depicts a graphical user interface generated by the illustrative embodiment of the present invention to allow a user to select a mass filter window.

### DETAILED DESCRIPTION

The illustrative embodiment of the present invention provides a mechanism for analyzing unexpected metabolites. A control sample is run in a metabolite analyzing system such as an LC-MS-MS system, and chromatographic data from the components exiting the LC phase is saved. The control sample components are added to an exclusion list. Subsequently, a single analyte sample is run on the metabolite analyzing system. The components are compared to the exclusion list upon exiting the liquid chromatography phase of the system. Common components are eliminated and the remaining components which may contain unexpected metabolites are analyzed. The ability to perform the filtering of the data in real time enables the system to be run programmatically and also enables the operators to avoid having to perform a second analyte sample run.

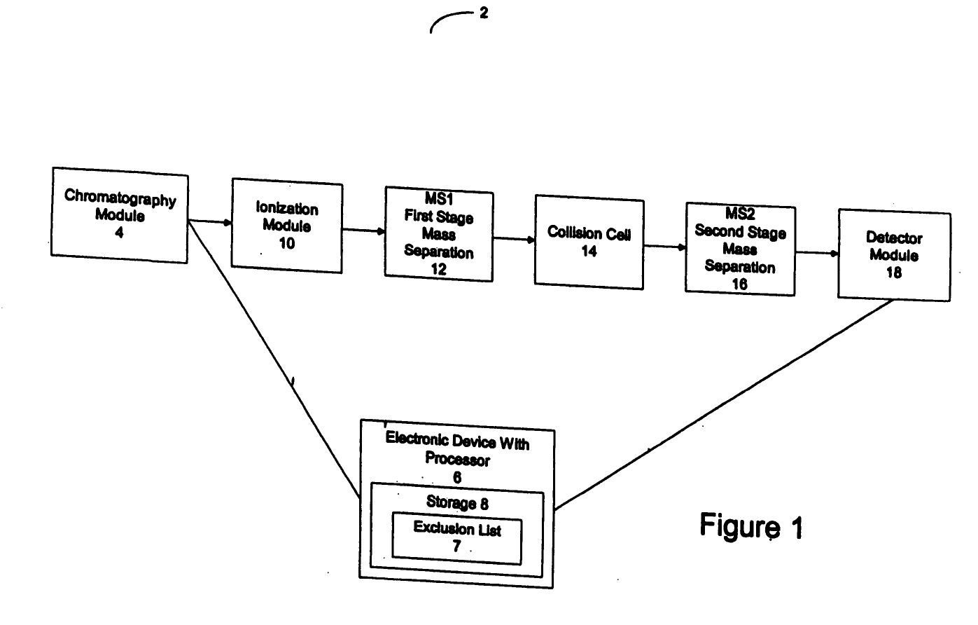

The present invention is performed in a metabolite analyzing system such as an LC-MS-MS system as depicted in FIG. 1. Other types of metabolic analyzing systems such as LC-MS systems may be used instead of an LC-MS-MS system without departing from the scope of the present invention. The metabolite analyzing system 2 includes a chromatography module 4, such as a liquid chromatography module. Also included is an ionization module 10. The ionization module 10 receives as an input sample the output from the chromatography module 4. The ionization module performs ionization of the sample. Those skilled in the art will recognize that there are a number of different ways in which the sample may be ionized, such as by bombarding the sample with a stream of high energy electrons.

The ions produced by the ionization module 10 are passed on to the MS1 first stage mass separation module 12. The mass separation may be performed using any of a number of well-known techniques. For example, the ions may be subjected to magnetic forces which alter the path of the ions based upon the mass of the ion. The separated ions are then be passed into a collision cell module 14 where they are subjected to additional reactions, such as exposure of the ions to a gas designed to react with the separated ions. The sample may be further separated in an MS2 second stage mass separation module 16 prior to arriving at a detector module 18. The detector module 18 is used to generate a mass spectrum based on the detected signal generated by the exiting ions. Those skilled in the art will recognize that a number of different methods of mass separation may be used and different substances may be introduced into the collision cell 14 in order to react with the ions of particular interest. Similarly, the illustrative embodiment of the present invention may also be performed with a number of different metabolite analyzing systems including an LC-MS system performing only one stage of mass separation.

An electronic device with a processor 6 is interfaced with the detector module 18 and the chromatography module 4. The electronic device 6 may be a server, desktop computer system, laptop, mainframe, network attached device or some other similar device with a processor. The electronic device may also be integrated into one of the modules in the metabolite analyzing system 2 without departing from the scope of the present invention. The electronic device 6 includes storage 8 which holds an exclusion list 7. Those skilled in the art will recognize that the storage 8 may be located in any location accessible to the metabolite analyzing system.

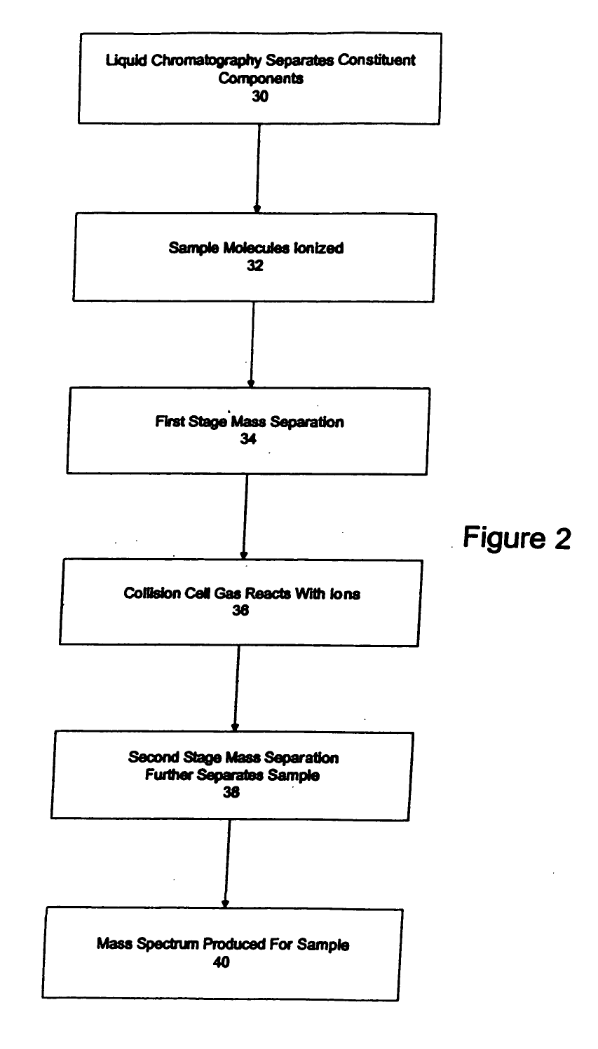

The sequence of steps performed to conduct a single LC-MS-MS run is depicted in the flow chart of FIG. 2. The sequence begins with a liquid chromatography separation of the components in a sample (step 30). The sample components exiting from the liquid chromatography system are passed into the ionization module 10 where ionization is performed (step 32). The first stage of mass separation is performed (step 34) and the separated ions are passed into the collision cell where they react to the collision cell reactant (step 36). Second stage mass separation is then performed on the reacted ions exiting from the collision cell (step 38). The separated ions are passed into the detector module 18 where a mass spectrum is generated from collected data thereby enabling the identification of metabolites contained within the sample (step 40).

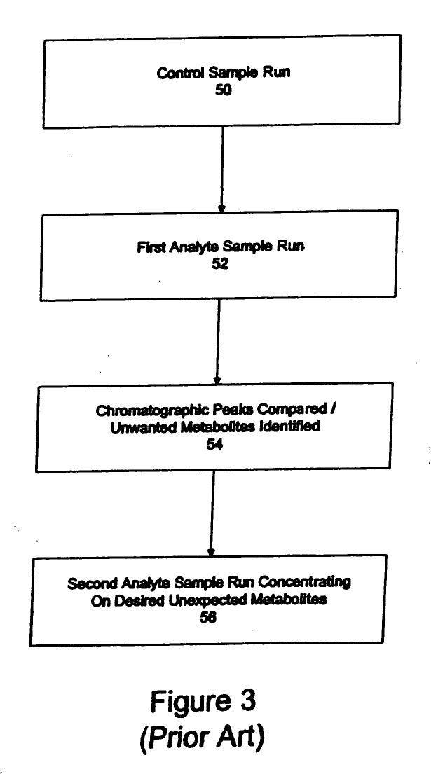

FIG. 3 is a flow chart of the prior art sequence of steps used to process an analyte sample. The sequence begins with a control sample being run through the metabolite analyzing system (step 50). A first analyte sample is then run through the analysis system (step 52). The chromatographic peaks generated by each run are then compared by an operator of the analysis system. Common components are identified by the operator (step 54). A second analyte sample is run after the analysis system is re-calibrated to focus on the components unique to the analyte sample which contain the desired unexpected metabolites (step 56).

The necessity of comparing the control sample run and the first analyte sample run usually requires the participation of a human operator of the system. It produces exclusion parameters for the second analyte sample run that are specific to the analyte sample but is a time-intensive process. The present invention produces a tailored list of unwanted components (which contain unwanted metabolites) that is generated programmatically and quickly from the single control sample run. The unwanted components in the control sample are added to an exclusion list. The exclusion list is accessible to software controlling the detector module and enables the real time filtering/configuration of the first and only analyte sample run so that the run focuses on the components containing the desired unexpected metabolites. This saves time in the analysis process as a second analyte sample run is not necessary. Additionally, the control sample generated-exclusion list is shorter than non-tailored lists and results in a quicker screening process since only data of interest is processed.

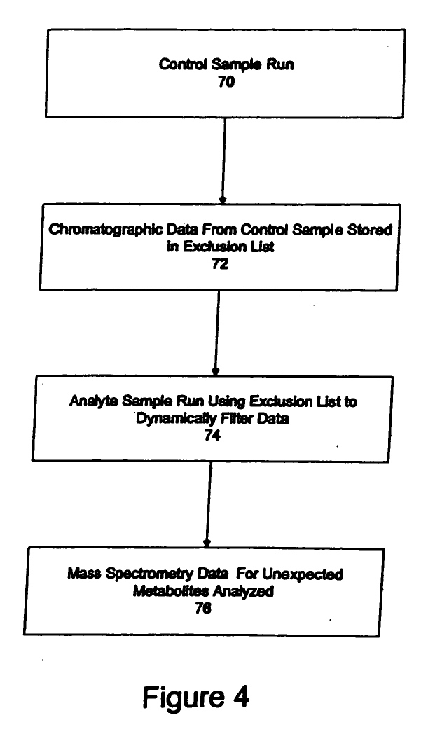

The more streamlined sequence of steps followed by the present invention to analyze unexpected metabolites is depicted in the flow chart of FIG. 4. The sequence begins as previously with a control sample being run through the metabolite analyzing system (step 70). The chromatographic data from the control sample is saved in an exclusion “list” (step 72). Those skilled in the art will recognize that the chromatographic data may be stored in a number of different data structures without departing from the scope of the present invention. The analyte sample run is conducted using the exclusion list to dynamically filter the data during the run (step 74). The detection module 18 is able to identify unexpected metabolites of interest and convey that information to the first stage MS1 mass spectrometer module 12 which is then able to divert the unexpected metabolites of interest into the collision cell. In this manner, the detection module 18 need only analyze for the unexpected metabolites of interest contained within the components unique to the analyte sample. The mass spectrometry data for the targeted metabolites may then be analyzed (step 76). The process can be performed programmatically without the necessity of having a system operator stand by to monitor the operation.

The comparison of the control sample chromatographic data to the analyte sample data may be programmatically represented as:

// Search for unexpected metabolites in peaks created from
non-MS Data traces

if ( m_pcChroPeak−>GetMetaboliteType( ) ==

ChroPeak::unexpected ∥

m_pcChroPeak−>GetMetaboliteType( ) == ChroPeak::all )

{

if ( m_pcMetabolitePars )

if ( !bSampleIsControl ∥
m_pcUnexpectedMetabolitePars-

>ExcludeControlMasses( )

| | | |
|---|---|---|
| if | ( | m_pcUnexpectedMetabolitePars- |

>FindUnexpectedMetabolites( ) )

{

bSearchDone = true;
CheckForUnexpectedMetabolites(

bSpectrumContainsParent, bSampleIsControl );

}

}

Similarly, the addition of the masses represented by the chromatographic peak to the exclusion list may be programmatically represented as:

| //In the routine that does the general preparation of parameters: | |
|---|---|
| // TGR 3740 Exclude Control Sample Masses | |
| // Add the Control Sample Unexpected Metabolites to ExcludeMassList | |
| AddControlMassesToExcludeMassList ( ); | |
| Definition of new routine: | |
| /******************************************************************* | |
| ***** | |
| METHOD: | AddControlMassesToExcludeMassList |
| CLASS: | APSample |
| PURPOSE: | Create the Exclude Mass List by adding entries from the |

control sample to those specified in the parameters.

| | |
|---|---|
| COMMENTS: | TGR 3740 |
| RETURNS: | void |

*******************************************************************
*****/
void APSample::AddControlMassesToExcludeMassList ( void )
{

| | |
|---|---|
| m_cUnexpectedMetabolitePars | = |

m_cAutoProcParsData.UnexpectedMetabolitePars( );

// Is sample an analyte with a control?
if ( !m_pControlSample )

return;

// MS/MS processing only?
if ( m_bAutoMSMSRun )

return;

| // Has the user requested this feature? | |
|---|---|
| if | ( |

!m_cAutoProcParsData.UnexpectedMetabolitePars( ).FindUnexpectedMetabolites( )
)

return;

| | |
|---|---|
| if | ( |

!m_cAutoProcParsData.UnexpectedMetabolitePars( ).ExcludeControlMasses( ) )

return;

| | |
|---|---|
| BOOLbUseTimes | = |

m_cAutoProcParsData.UnexpectedMetabolitePars( ).ExcludeControlTimes( );

// Do we have the information in the control sample?
if ( m_pControlSample−>GetUnexpectedMetaboliteCount( ) <= 0 )

return;

// Loop through metabolites, adding each unexpected one to the list
for ( int nMetabolite = 0; nMetabolite < m_pControlSample-

>GetMetaboliteCount( ); nMetabolite++ )

{

CMetaboliteData *pMetabolite = m_pControlSample−>GetMetabolite

(nMetabolite);

if ( !pMetabolite )

continue;

if ( !pMetabolite−>IsUnexpected( ) )

continue;

double fTime = 0.0;
if ( bUseTimes )

fTime = pMetabolite−>GetPeakTime( );

m_cUnexpectedMetabolitePars.AppendToExcludeMassList(pMetabolite-

>GetMzFound( ), fTime);

}
// Sort the mass list into ascending order
m_cUnexpectedMetabolitePars.Sort( );
return;

}

Those skilled in the art will recognize that the raw data from both the control sample run and the analyte sample run are saved in a database where they can be reviewed later to verify the accuracy of the unattended analysis as a quality control check. The data, both the raw data and the analyzed data, may be saved in a multi-dimensional array or other data structure from which the required information may be retrieved.

The illustrative embodiment of the present invention may be used to identify impurities in a drug sample. Similarly, it may also be used to enforce patent rights by analyzing the by-products of a chemical reaction in order to diagnose a possible chemical infringer. Additionally, the illustrative embodiment of the present invention may also be used to analyze natural products and to determine their purity level. The list of metabolites created by using illustrative embodiment of the present invention may be used to trigger fraction collection in MS or MS/MS modes, i.e. precursor ion, neutral loss or product ion with or without exact mass. Those skilled in the art will recognize that the analysis system revealed herein may use analysis system components other than mass spectrometry to analyze the analyte sample and that gas chromatography may be substituted for liquid chromatography without departing from the scope of the present invention. Additionally, the present invention may be used to identify and analyze other substances contained within a sample in addition to metabolites.

Additional processing and filtering may be conducted using mass data from a mass spectrometer. A mass filter window using exact mass can be applied around the mass of the metabolite to include it or exclude it from the results. The mass value must contain a minimum of four decimal places in order to apply this additional filter window. The need for four decimal places is applicable to all exact mass data obtained from a mass analyzer in both MS and MS/MS modes of analysis. Since a user performing analysis is aware of the mass decimal place values for a starting drug or compound, the use of a mass filter window using exact mass can help to exclude false positives.

An examination of the drug Verapamil may be used to illustrate the use process performed by the illustrative embodiment of the present invention. In this case, Verapamil is the parent drug with a N-dealkylated metabolite. A mass window of around ±70 mDa or ±0.070 may be placed around the found metabolite to exclude false positives. 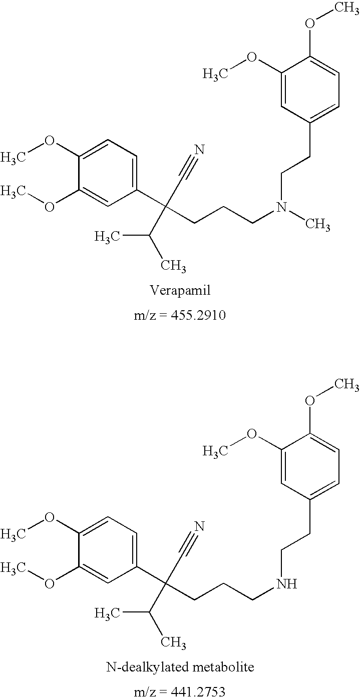
The parent drug Verapamil has a mass of 455.2910. By adding a ± filter of 0.070 (a mass value with four decimal places) to the starting mass of Verapamil, the illustrative embodiment of the present invention displays only unexpected metabolites identified using the method described above that have a mass between 455.2210 and 455.3610. The application of the mass window restricts the generated results to unexpected metabolites that are close to Verapamil's mass. Since the identified unexpected N-dealkylated metabolite has a mass of 441.2753 which is within the window, it will be displayed in the generated results.

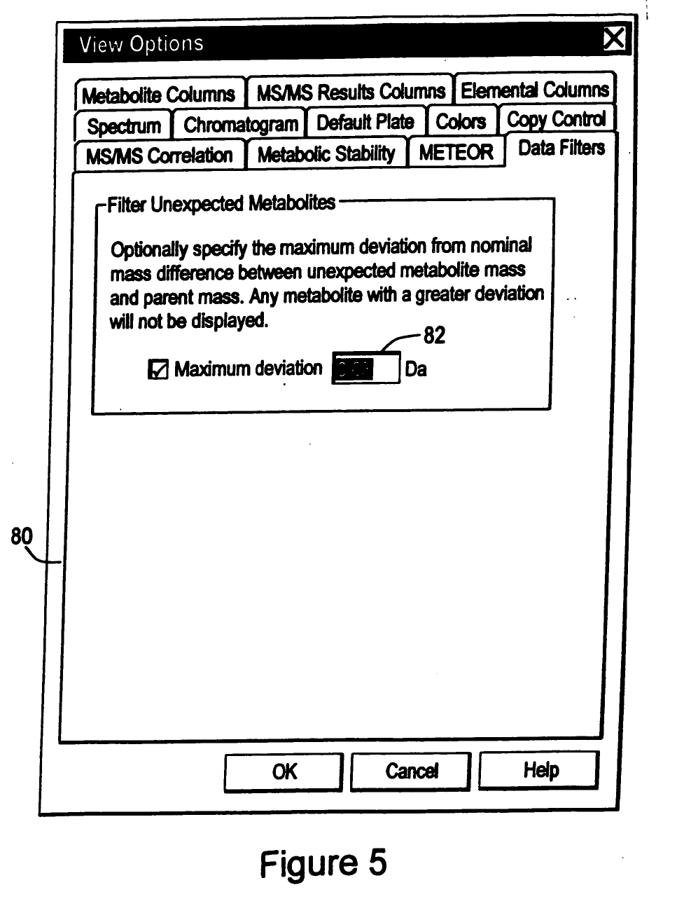

The illustrative embodiment of the present invention allows a user to quickly select the size of the mass window to be applied to the identified unexpected metabolites. FIG. 5 depicts a graphical user interface 80 which may be displayed to a user to allow the user to specify the size of the window. In the displayed implementation, the user types the size of the maximum deviation into a control window 82 in the graphical user interface 80. Only those samples within the specified deviation will be displayed in the results. Those skilled in the art will realize that other ways of indicating the size of the maximum deviation such as radio buttons, slider controls, pull down menus and the like may also be used to specify the size of the maximum deviation without departing from the scope of the present invention. Similarly, multiple windows may be displayed to a user simultaneously and non-contiguous result data may also be displayed in an alternate implementation.

It should be noted that the illustrative embodiment of the present invention leaves the raw data relating to the identified unexpected metabolites undisturbed for later viewing. That is, the user has the opportunity to go back to the raw data and re-apply different sizes of mass windows and/or perform different types of analysis to the original data. The application of the mass window does not disturb the original data.

Since certain changes may be made without departing from the scope of the present invention, it is intended that all matter contained in the above description or shown in the accompanying drawings be interpreted as illustrative and not in a literal sense. Practitioners of the art will realize that the sequence of steps and architectures depicted in the figures may be altered without departing from the scope of the present invention and that the illustrations contained herein are singular examples of a multitude of possible depictions of the present invention.

We Claim:

1. A method for analyzing metabolites, comprising:
analyzing programmatically with a metabolite analysis system a single control sample to determine unwanted metabolites;
with said metabolite analysis system, adding programmatically said determined unwanted metabolites to an exclusion list; and
evaluating programmatically with said metabolite analysis system an analyte sample for unexpected metabolites using said exclusion list.

2. The method of claim 1 wherein said metabolite analysis system is one of an LC-MS (liquid chromatography-mass spectrometry) system and LC-MS-MS (liquid chromatography-mass spectrometry-mass spectrometry) system.

3. The method of claim 2 wherein the determined unwanted metabolites are added to the exclusion list by a reference to saved chromatographic data, said saved chromatographic data generated by said single control sample.

4. The method of claim 1 wherein said evaluation filters out unwanted metabolites identified in said exclusion list during the analyte sample run.

5. The method of claim 4 wherein said evaluation filters out unwanted metabolites by comparing chromatographic data generated from a liquid chromatography phase of said analyte sample run to a collection of saved chromatographic data generated by said single control sample, said saved chromatographic data referenced by said exclusion list.

6. The method of claim 1 wherein said exclusion list is used to evaluate an analyte sample for natural product identification and discovery.

7. The method of claim 1 wherein said exclusion list is used to perform an impurity analysis on a sample.

8. The method of claim 1 wherein said exclusion list is used to evaluate a sample to perform compound patent protection.

9. The method of claim 1 wherein said exclusion list is used to trigger MS/MS directed fraction collection.

10. The method of claim 1 wherein said metabolite analysis system includes gas chromatography.

11. The method of claim 1, said method further comprising:
applying a mass filter window to the mass of the identified unexpected metabolite in order to exclude false positives, said mass filter window containing a mass of one of a known starting drug or starting compound.

12. The method of claim 1, said method further comprising:
applying a mass filter window to the mass of the identified unexpected metabolite, said mass filter window containing a designated mass value.

13. In an electronic device interfaced with a metabolite analysis system, a medium holding executable steps for a method, said method comprising the steps of:
analyzing programmatically with a metabolite analysis system a control sample to determine unwanted metabolites;
with said metabolite analysis system, adding programmatically said determined unwanted metabolites to an exclusion list; and
evaluating programmatically with said metabolite analysis system an analyte sample for unexpected metabolites using said exclusion list.

14. The medium of claim 13 wherein said metabolite analysis system is one of an LC-MS (liquid chromatography-mass spectrometry) system and LC-MS-MS (liquid chromatography-mass spectrometry-mass spectrometry) system.

15. The medium of claim 14 wherein the determined unwanted metabolites are added to the exclusion list by a reference to saved chromatographic data, said saved chromatographic data generated by said single control sample.

16. The medium of claim 13 wherein said evaluation filters out unwanted metabolites identified in said exclusion list during the analyte sample run.

17. The medium of claim 16 wherein said evaluation filters out unwanted metabolites by comparing chromatographic data generated from a liquid chromatography phase of said analyte sample run to a collection of saved chromatographic data generated by said single control sample, said saved chromatographic data referenced by said exclusion list.

18. The medium of claim 13 wherein said exclusion list is used to evaluate an analyte sample for natural product identification and discovery.

19. The medium of claim 13 wherein said exclusion list is used to perform an impurity analysis on a sample.

20. The medium of claim 13 wherein said exclusion list is used to evaluate a sample to perform compound patent protection.

21. The medium of claim 13 wherein said exclusion list is used to trigger MS/MS directed fraction collection.

22. The medium of claim 13 wherein said metabolite analysis system includes gas chromatography.

23. The medium of claim 13, wherein said method further comprises:
applying a mass filter window to the mass of the identified unexpected metabolite in order to exclude false positives, said mass filter window containing a mass of one of a known starting drug or starting compound.

24. The medium of claim 13, wherein said method further comprises:
applying a mass filter window to the mass of the identified unexpected metabolite, said mass filter window containing a designated mass value.

25. A metabolite analysis apparatus comprising:
a chromatography module;
at least one mass spectrometry module;
an electronic device holding a storage location, said storage location holding chromatographic data generated by said chromatography module for a single control sample; and
an exclusion list of identified metabolites, said exclusion list including a reference to the saved chromatographic data; said exclusion list being programmatically applied to an analyte sample to identify unexpected metabolites.

26. The apparatus of claim 25 wherein said chromatography module is a liquid chromatography module.

27. The apparatus of claim 25 wherein said chromatography module is a gas chromatography module.
